(19) United States
(12) Patent Application Publication
(10) Pub. No.: US 2026/0361155 A1
(43) Pub. Date: Nov. 12, 2026

(54) End Plate for a Laminated Core of a Stator

(71) Applicant: Bayerische Motoren Werke Aktiengesellschaft, Muenchen (DE)

(72) Inventors: Martin OBERMUELLER, Linz (AT); Daniel SALCHER, Kleinreifling (AT); Georg WINKLER, St. Marien (AT)

(21) Appl. No.: 19/129,693

(22) PCT Filed: Oct. 17, 2023
(86) PCT No.: PCT/EP2023/078732

§ 371 Date: May 14, 2025

(30) Foreign Application Priority Data
Nov. 15, 2022 (DE) 10 2022 130 168.0

(51) Int. Cl. H02K 1/20; H02K 9/19

(52) U.S. Cl. CPC H02K 1/20; H02K 9/19

(57) ABSTRACT

An end plate for a laminated core of a stator of an electric machine includes an annular ring contour, which extends between one side of the laminated core and a winding head side of the end plate, and multiple radial guide openings on the laminated core side which are mutually spaced in the circumferential direction of the annular contour. A collar support finger is on a circumferential region of one, several or all of the plurality of radial guide recesses, each collar support finger extending radially inward.

### BACKGROUND AND SUMMARY

The invention relates to an end plate for a laminated core of a stator of an electric machine and a stator for an electric drive machine in a motor vehicle.

If, in an electric drive machine for a motor vehicle, the necessary cooling of the stator takes place via cooling channels close to the slot, a number of challenges arise in connection with the coolant routing beyond the laminated core to the winding heads and with the assembly of the stator.

With regard to the coolant supply, the challenge is to ensure that the winding heads are sufficiently and evenly wetted with coolant spray. In known solutions, this is achieved by a complicated arrangement of differently punched individual plates in the assembly of the laminated core. Such a solution implies a massive increase in the complexity of the punching process and an associated increase in costs.

In terms of production, the problem is that each winding slot, in which the enameled copper wire and slot insulation paper are located, must be filled with trickle resin to at least a certain degree. This ensures that the conductors remain insulated from each other on the one hand and cannot become acoustically conspicuous on the other. However, this trickling process on the laminated core can lead to deposits of trickling resin on the end faces. This is problematic when using additional coolant channels close to the winding groove (also known as close to the groove), through which a coolant is to flow during operation, because the deposits—or in the worst case even a trickle resin blockage—hinders or prevents the required circulation of the coolant to the winding heads and thus impairs cooling.

Against this background, it is a task of the invention to improve the cooling of the winding heads of a stator, in particular for an electric drive motor of a motor vehicle.

Each of the independent claims defines with its features an object which solves this task. The dependent claims relate to advantageous further embodiments of the invention.

According to one aspect, an end plate for a laminated core of a stator of an electric drive machine, in particular in a motor vehicle, is disclosed.

The end plate has an annular contour with an annular wall thickness which extends between a laminated core side—i.e. a side which is designed to face the laminated core—and a winding head side—i.e. a side which is designed to face a winding head of the stator—of the end plate.

Furthermore, the end plate has several radial guide recesses on the laminated core side of the ring wall thickness, spaced apart from one another in the circumferential direction, which are each set up to guide a coolant flow from a coolant axial channel of the laminated core arranged radially further inwards on the stator to a coolant outlet arranged radially further outwards on the end plate and facing the winding head side, in particular in cooperation with a side wall of an outer plate of the laminated core. By guiding the coolant radially outwards on the end plate, it is possible to ensure that the entire winding head is wetted, particularly outwardly from the radial, even in the case of axial coolant channels close to the groove, which may, for example, be arranged at an overlapping radial position with the winding grooves

In addition, the design of the coolant outlets on a separately formed end plate (instead of on the laminated core itself) reduces the risk of inadvertently blocking the coolant outlets with the trickling resin for filling the winding grooves away from the respective winding.

Furthermore, the design of coolant outlet nozzles in sheets of the laminated core itself has a negative effect on the electromagnetic properties of the laminated core, so that their formation on the end plate instead has an advantageous effect.

According to a further aspect, a stator for an electric drive machine in a motor vehicle is disclosed. The stator has a laminated core with a plurality of winding slots and a plurality of axial coolant channels, which are arranged in the circumferential direction between the winding slots. The stator has a stator winding head on both sides of the laminated core, starting from the respective axial ends of the winding slots. An end plate according to one embodiment of the invention is arranged on both sides of the laminated core.

The invention is based, inter alia, on the consideration that the end face openings of the cooling channels close to the slots look out of or are aligned with the laminated core in several unfavorable ways with regard to their position. The representation of spray holes in the outer sheets of the laminated core is very complex and cannot be represented electromagnetically without losses. Likewise, as described at the beginning, the automated trickling process is difficult to carry out in such a way that the openings are reliably sealed. Spray nozzles punched into the sheet stack have a negative electromagnetic effect and cause a deterioration in the active length. This results in a deterioration in the power-related relative weight of the stator. The invention is now based, among other things, on the idea of providing an end plate on both sides of the laminated core, which is designed, for example, as a coolant transfer plate.

The end plate solves the problems described for stators cooled close to the groove with oil by guiding the cooling medium flow radially outwards to a larger radius, where it can be transferred to a separate winding head cooling module or sprayed out, for example. This also prevents blockages in the openings of the axial channels when the stator is trickling and any masking required to protect the openings can be applied more easily. This is because the openings of the channels are then no longer in the immediate vicinity of the trickling resin nozzle.

Steel, for example, is a suitable material for the transfer plate because it can be attached to the laminated core with baking varnish, just like the plates of the laminated core itself. In addition, a step in the housing can ensure that the transfer plate is pressed against the stator. The end plate is then designed in such a way that there is no deterioration in the air and creepage distance between the copper (Cu) conductors of the winding heads and the laminated core, so that the winding head dimensions do not deteriorate despite the installation of the end plate.

Alternatively, a dielectric plastic material (e.g. PA6 or PA12) can be considered as a material, for example if simultaneous packaging of the transfer contour with the rest of the laminated core is not possible. Such an end plate could be made in one piece when bonded before stator production, or in several pieces when screwed onto the laminated core after stator production in order to take into account the undercut of the radial oil channels behind the conductors. A plastic end plate can then have a high-temperature-resistant hard component for the transfer geometry and a high-temperature-resistant soft component for the sealing surface to the laminated core and can be manufactured using a multi-component injection molding process, for example. Screws can be used, for example, with countersunk screws that do not protrude from the contour. In one embodiment, the radial guide recesses are spaced apart from each other, in particular evenly, according to the positioning of the coolant axial channels. This means that the coolant can be guided axially outwards directly from one axial end of each coolant axial channel.

According to one embodiment, a coolant outlet is jointly assigned to each radial guide recess or in each case two or more radial guide recesses. In the first alternative embodiment, the coolant that has flowed through a specific coolant axial channel can cool the assigned part of the winding head at the corresponding contact position. In the second alternative design, the coolant can still be sprayed out effectively even under unfavorable pressure conditions because fewer outlets need to be operated. With a separate coolant outlet for each coolant axial channel, the required pump pressure would be very high and the efficiency of the machine would be reduced. If the pressure were kept the same, only a trickle would come out of the holes, which would end up in the air gap. For this reason, it is necessary to reduce the number of openings. To make matters worse, the smaller the holes are punched, the shorter the service life of the punching tools would be. Many small holes must be weighed against fewer, larger holes.

According to one embodiment, the coolant outlet is designed as a spray nozzle, in particular for wetting the winding heads with coolant and/or aligned towards the winding heads. In this design, the winding head can already be sufficiently sprayed or wetted with coolant, depending on the appropriate design of the coolant outlet(s). The oil ducts on the sheet metal package side can either be fed into a single collection volume or into several collection volumes (number smaller than the number of oil ducts).

According to an alternative embodiment, the coolant outlet is designed as a coolant interface to a winding head cooling module, which is designed for suitable distribution of the coolant to the winding head. In this embodiment, a further coolant guide is provided downstream of the end plate, and in particular downstream of the coolant outlets, which is designed in such a way that the title head can be optimally or as required wetted with coolant. According to one design, a coolant outlet located further down in the installation position of the stator is designed with a smaller cross-section than a coolant outlet located further up. This may compensate for the effect of gravity in the distribution of the coolant at the individual coolant outlets and/or the fact that upper sections of the winding head may be cooled exclusively by the coolant sprayed on there, while our sections of the winding head can also be cooled by the coolant that runs off from the upper sections.

According to one embodiment, the end plate is made of a steel material. In particular, it is made of a steel material. In particular, the end plate has a dielectric layer surrounding the contour of the end plate completely or only on the winding head side.

According to an alternative embodiment, the end plate is made of at least one, in particular dielectric, plastic material. This means that the end plate can be arranged axially between the laminated core and the winding head without any problems, in particular on the teeth between the grooves, without causing problems with clearance and creepage distances. An axial extension of the stator is not necessary for this. With a suitable design, the end plate can even contribute to the electrical insulation of the laminated core and the center head from each other, so that an axial shortening of the stator may even be possible.

In particular, the end plate is designed as a multi-component part with a hard component to form the radial guide recesses and the annular contour, and with a soft component to form a sealing surface to the laminated core. In this way, an end plate that meets both the structural requirements and the sealing requirements for the coolant guide can be manufactured in a known, and therefore simple and inexpensive, manner.

According to one embodiment, several seals spaced apart from one another in the circumferential direction of the annular contour and formed circumferentially around one or more radial guide recesses are provided, in particular as soft components. This makes it easier to form a reliable seal than with a single seal running along the entire circumference of the annular contour.

According to one design, at least one recess is also arranged in the circumferential direction between two radial guide recesses, so that the radial guide recesses are delimited by a remaining web, at the extent of which the end plate has the full ring wall thickness. This allows the end plate to be designed with the lowest possible dead weight.

According to one embodiment, the end plate is made up of two or more, in particular six, in particular identically designed, circumferential parts, which can be assembled in such a way that they form a circumferentially rotating end plate. An end plate composed of several components can be noted more easily-in particular even after the windings have been inserted into the winding grooves. This ensures optimized cooling of both winding heads and enables undercut positioning of the component between the conductor tracks, for example after the windings have been inserted.

According to one embodiment, the end plates are baked to the stack of sheets by means of a baking varnish, either completely or in a sufficiently coolant-tight manner depending on the application, in particular in a bonding process that is carried out together with the baking of the sheet of the stack of sheets. Additionally, or alternatively, the trickling process can be designed in such a way that the trickling resin itself also contributes to the tightness of the system. The capillary effect of the minimally spaced, individual sheets can be utilized, as the trickling resin is applied at the necessary positions anyway. This makes the stator particularly easy to manufacture—especially with very few steps.

According to an alternative design, the radial guide recesses on the laminated core side of the end plates are delimited with an elastic plastic component and braced, in particular screwed, to the laminated core in such a way that the respective radial guide recess and the associated side of the laminated core delimit a radial guide in a coolant-tight manner. In this way, the end plate can be made entirely from a dialectic plastic—for example as a 2-component part so that the stator can be optimized electromagnetically and possibly also with regard to its axial dimensions.

One possibility for assembling stators is by means of a hairpin twist process.

A hairpin twist process (also known as a hairpin process chain) is an indirect process for way manufacturing windings, particularly in the stators of drive machines. Due to the massive conductor cross-section, the geometry of the hairpins is adapted before the assembly process for inserting the plug-in coils into the laminated core. In contrast to conventional stator production (with its winding-based assembly processes), a forming-based assembly process is used here. A typical hairpin process chain normally has several higher-level process steps:
(i) Hairpin production: this involves continuously unwinding and straightening the typically already enameled flat copper wire, possibly in multiple stages, to reduce residual bends and residual stresses. As the copper ends of the individual hairpins are normally welded together in a later process step, the hairpin wire can be partially stripped after the straightening process, either by laser or mechanically. Depending on the desired hairpin geometry, the hairpin wire is cut to length and bent using a cutting process. The sequence of bending and cutting operations can vary. Hairpins are formed into the desired, possibly three-dimensional, geometry. This process takes place either in a single stage using special CNC bending systems or in multiple stages with die bending and swivel bending.
(ii) Assembly and twisting: As direct assembly of the hairpins in the laminated core is limited by overlaps in the winding head geometry and reliable insertion into the stator assembly must be ensured, the hairpins are usually pre-assembled in a so-called assembly buoy. The arrangement of the individual pins in the pre-assembly depends on the winding scheme. A hairpin stator typically has at least three, usually up to 21 or more, different hairpin geometries. Insulation paper is inserted into the stator slots parallel to the pre-assembly. This serves to separate the winding system from the earth potential of the laminated core. Once the hairpins have been fully pre-assembled, the entire hairpin basket (also known as the hairpin nest) is inserted axially into the laminated core using a multiple gripper system. Due to very low tolerances, hairpins are sometimes provided with chamfers during the cutting process—positioning holders are also used if necessary. Depending on the winding pattern, the hairpin ends are interlocked with each other in each layer. This process is also known as the twist process. In addition to the twisting movement, the assembly tool also moves in an axial direction. To ensure axial access for a setting tool, the hairpin ends must be radially exposed in a preparatory step. The crux of the subsequent production step of twisting lies in the start of the bending of the wires axially from the end face of the laminated core. If bending takes place too early, the slot insulation paper can tear, the LuK distances are undercut and damage is to be expected. In order to initiate the bending radius at the correct point, the collar support fingers are fed radially and the bend is initiated at their shoulder.

For this reason, so-called collar support fingers are used when twisting the hairpins, which ensure that the correct twist radius is applied radially between the conductors at the correct point on each hairpin. These support fingers are designed differently depending on the system supplier, but what they all have in common is the radial infeed and the axial support of the bending forces in the sheet metal package.
(iii) Welding and interconnection: Adjacent hairpin ends are now contacted with each other according to the circuit diagram. As a rule, a laser welding process is used for this, which melts the hairpin ends and joins them together with a material bond. During the welding process, attention should be paid to homogeneous weld seam geometries and minimizing thermal input into the hairpins. In order to be able to pursue reproducible welding strategies, a particular challenge lies in the creation of a consistent weld exit situation. Height and lateral offset of the hairpin ends in relation to each other can lead to welding defects. To counteract this, correction processes are sometimes used depending on the tolerances of upstream processes.
(iv) Rendering of a hairpin stator: to realize phase jumps and the winding connection, interconnection elements such as contact rings, jumpers, terminals or jumpers are then connected to the welded hairpin ends. This process is usually also carried out by a laser welding process.

Secondary insulation: after wiring, the welded copper ends are insulated in the final step and the stator is impregnated if necessary. The copper ends are usually insulated by powder coating or the application of casting resins, for example on a polyurethane basis. Impregnation, trickling or full encapsulation processes are typically used for casting. Impregnation can be carried out in the same way as impregnation processes in the manufacture of conventionally wound stators. Impregnation is used to protect against thermal, electrical, environmental and mechanical influences. Usually, dipping or trickling processes are also used for impregnation.

In hairpin twist processes, protrusions on the front of the laminated core that extend beyond the active magnetic length impair the handling capability in production and hinder the hairpin twist process.

According to one embodiment, the collar support fingers are formed on the end plate, in particular integrally with it, and solve the manufacturing problem during twisting by means of a geometry analogous to the collar support fingers, for example deep-drawn, on the end face of the laminated core, which then remains on the stator.

The coolant-carrying part is manufactured using 2K injection molding in such a way that the twisting results in axial compression with the sheet metal package, which ensures coolant tightness. The challenge in designing the seal is to take into account both the springback of the wires after twisting and the thermal expansion of the various materials used.

According to one embodiment, the coolant-carrying part of the geometry is designed in such a way that the channels on the sheet metal package side are brought together in such a way that they can be guided radially further out towards the winding head at a suitable position:

According to one embodiment, the geometry is designed in such a way that there is no deterioration in the air and creepage distance between the copper conductor of the winding on the one hand and the laminated core on the other, as a result of which the winding head dimensions do not deteriorate.

According to one embodiment, the end plate has a collar support finger at a circumferential region, in particular at a circumferential position, of one, several or all radial guide recesses, which, in particular starting from the annular contour, extends radially inwards, in particular further than a radial position of one or more coolant axial channels. In other words, according to one embodiment, the end plate has a collar support finger at a circumferential position of each winding groove, which extends radially along part or all of a radial extension of the winding grooves of the stator, in particular starting from the annular contour. When twisting the hairpins, collar support fingers are used which ensure radially between the conductors that the correct twist radius is introduced at the correct point of each hairpin.

According to one version, the collar support finger(s) is/are made from the material of a hard component of a 2-component injection molded part. This means that the end plate is manufactured in such a way that the twisting process results in axial compression on both sides with the sheet stack, which ensures oil tightness. During the twisting process, the hairpins are pulled slightly towards the switching ring side, which is why the A side is constricted. For this reason, the collar support finger contour on the star ring is designed differently on the A and B sides.

The A-side contour has a shape that already takes into account the mechanical shaping of the hairpin roofs, while the B-side contour takes into account the twisting process.

According to one design, the collar support finger(s) is/are arranged within an axial area of the ring wall thickness. The collar support fingers integrated into the geometry solve the manufacturing problem during twisting by means of a geometry analogous to the collar support fingers, but which then remains on the stator.

According to one embodiment, the collar support finger(s), in particular in each case, have a support projection that extends beyond the axial extension of the annular contour on the winding head side with respect to a central axis of the circular contour of the end disc. This allows the hairpins to be twisted at a specified distance from the sheet stack, in particular without damaging the slot insulation paper.

According to one embodiment, the support projection has a rounded, roof-like support surface, which in particular extends radially and/or covers part of a fictitious plane of the annular contour. In this way, the hairpins can be bent on the support surface and/or supported after bending.

Further advantages and possible applications of the invention are shown in the following description in connection with the figures.

### BRIEF DESCRIPTION OF THE DRAWINGS

FIG. 1 shows a stator with two end plates according to a first exemplary embodiment of the invention.

FIG. 2 shows a section of the stator of FIG. 1.

FIG. 3 shows a partially sectioned view of one of the end plates of the stator of FIG. 1.

FIG. 4 shows a sectional view of the stator of FIG. 1.

FIG. 5 shows a view of the stator of FIG. 1 without the windings.

FIGS. 6A and 6B show the winding head side (in FIG. 6A) and the laminated core side of one of the end plates of the stator of FIG. 1 (in FIG. 6B).

FIG. 7 shows a section of an end plate that can alternatively be used in the stator of FIG. 1 according to a second exemplary design with a plurality of longer collar support fingers and a circumferential seal designed as an elastomer seal.

FIG. 8 shows on the left the laminated core side and on the right the winding head side of the alternative end plate from FIG. 7.

FIG. 9 shows a stator with two different end plates according to a third exemplary embodiment of the invention (on the “A” side of the electric drive machine) or a fourth exemplary embodiment of the invention (on the “B” side of the electric drive machine) in a side view.

FIG. 10 shows the stator of FIG. 9 in an oblique view of the “B” side.

FIG. 11 shows the end plate according to the third exemplary embodiment of the invention (on the “A” side of the electric drive machine) in an oblique frontal view.

FIG. 12 shows the end plate according to the third exemplary embodiment of the invention in a frontal view.

FIGS. 13A and 13B illustrate the difference in the supporting projections of the end plate according to the third exemplary embodiment and the fourth exemplary embodiment

FIG. 14 shows the end plate according to the third exemplary embodiment of the invention in a rear view of the radial guide recesses and of a plurality of individual seals of radial guide recesses formed as elastomer seals.

FIGS. 15A and 15B show different views of a sealed radial guide recess of the end plate from FIG. 14.

### DETAILED DESCRIPTION OF THE DRAWINGS

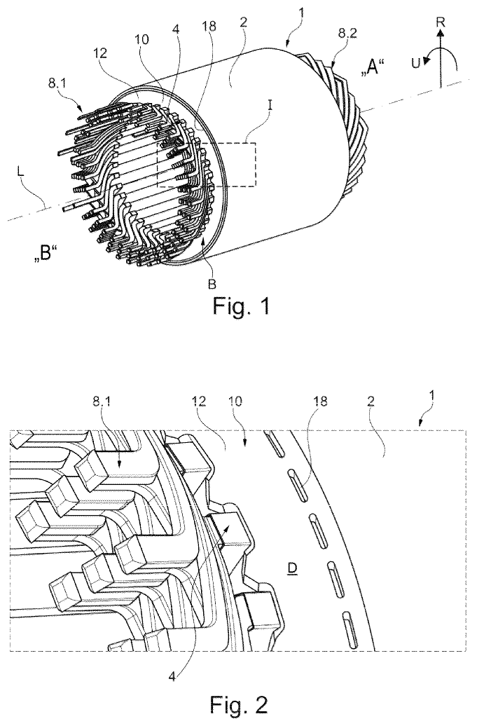

FIG. 1 shows a stator 1 for an electric drive machine in a motor vehicle. The stator 1 has a laminated core 2 with a plurality of winding slots 4 and a plurality of coolant axial channels 6, which are arranged between the winding slots 4 in the circumferential direction U. The stator 1 has a stator winding head 8.1 or 8.2 on each side of the laminated core 2, starting from the respective axial ends of the winding slots. An end plate 10 according to one embodiment of the invention is arranged on both sides of the laminated core 2.

Each of the two end plates 10 has an annular contour 12 with an annular wall thickness X_R, which extends between a sheet stack side P and a winding head side D of the end plate 10.

Furthermore, the end plate 10 has a plurality of radial guide recesses 14 on the laminated core side P, which are spaced apart from one another in the circumferential direction U and which are each set up, in cooperation with a side wall of an outer plate of the laminated core 2, to direct a coolant flow F from a coolant axial channel 16 of the laminated core 2, which is arranged further inwards on the stator 1 in the radial direction R, to a coolant channel arranged radially further outwards on the end plate 10 and directed towards the winding head side D and thus towards one of the stator winding heads 8.1 or 8.2 towards the coolant outlet 18.

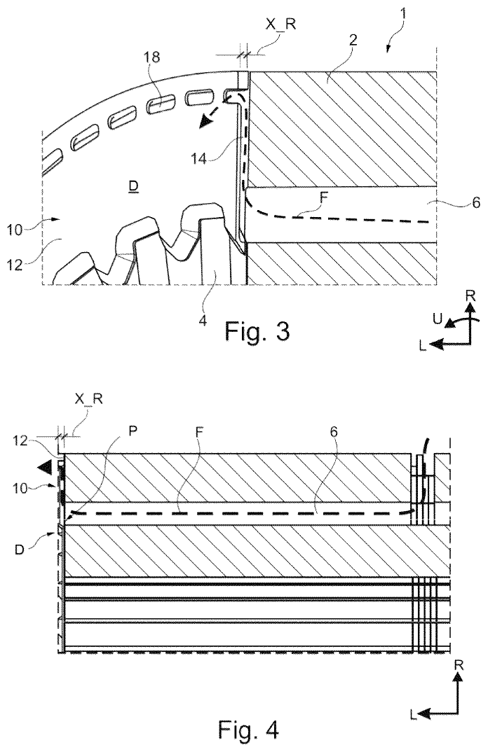

The geometry and function of the end plate 10 in general and the radial guide recesses 14 in particular can be seen clearly in FIG. 3 and FIG. 4 and FIG. 6B.

By guiding the coolant radially outwards on the end plate, wetting of the entire winding head from the radial outside can be ensured even with coolant axial channels close to the groove.

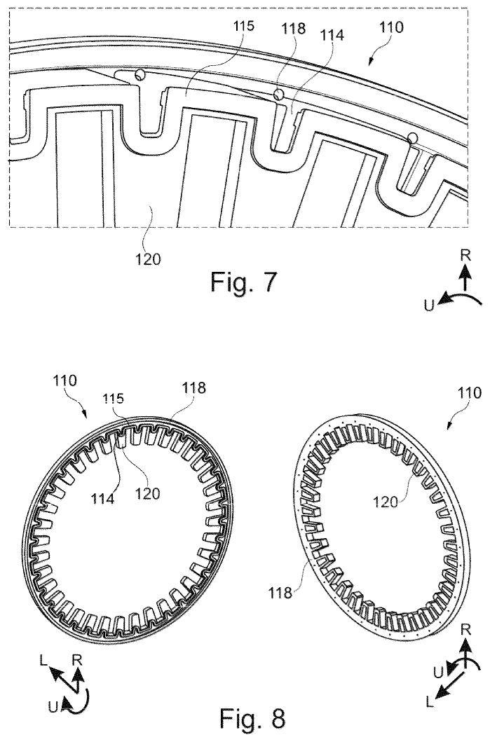

It can be seen from the enlarged section of FIG. 1 in FIG. 2 that in the embodiment example, the radial guide recesses 14 start radially so far inwards that their radially inner ends allow the end plate 10 to be aligned and/or fixed in the circumferential direction U. In the embodiment example of FIGS. 1 to 6, areas of the end plate are thus already formed that extend radially inwards. Nevertheless, these areas are not yet formed so far radially inwards that they can serve as collar support fingers 120 (see FIGS. 7 and 8) in the hairpin twist method. Another exemplary embodiment of an end plate 110 with such collar support fingers 120 is shown in FIGS. 7 and 8 and explained in the associated figure descriptions.

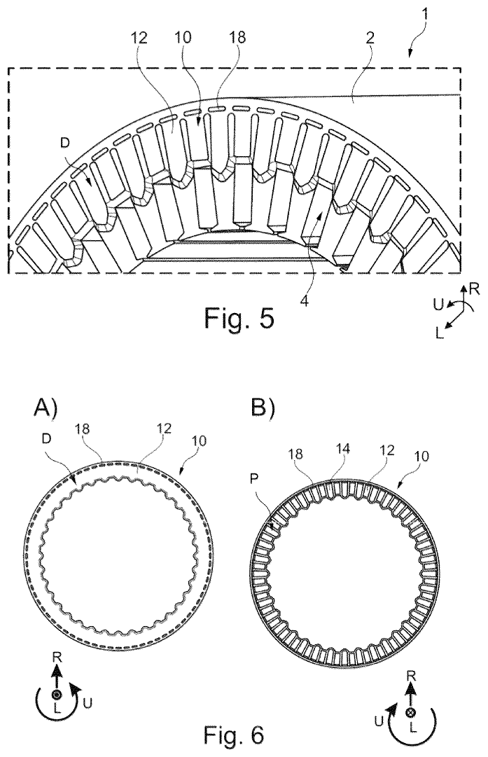

Further features and advantages can be seen from the various views of the first exemplary embodiment of the invention in FIG. 3, FIG. 4, FIG. 5 and FIG. 6:

The radial guide recesses 14 are arranged at the circumferential positions of the coolant axial channels 16, and are accordingly evenly spaced from one another in the circumferential direction. In this way, the coolant can be guided axially outwards directly from one axial end of each coolant axial channel.

In addition, a coolant outlet 18 is assigned to each radial guide recess 14. Therefore, the coolant that has flowed through a particular coolant axial channel can cool the associated part of the winding head at the corresponding contact position.

In the embodiment example, each of the coolant outlets 18 is set up to wet the winding heads with coolant and is directed towards the winding heads so that the coolant can spray out there.

In the design example, the end plate 10 is designed as a dielectric plastic component, manufactured using a 2-component injection molding process. A hard component made of a heat-resistant plastic is provided, which, among other things, together with a side surface of the outermost sheet of the sheet stack 2, delimits the radial guide recesses 14. In addition, a soft or elastic component made of another heat-resistant plastic is provided, which seals the contact surfaces between the end plate 10 and the sheet metal stack 2. This means that the end plate can be arranged axially between the laminated core 2 and the winding head 8 without any problems with clearance and creepage distances. An axial extension of the stator 1 is not necessary for this.

FIG. 7 and FIG. 8 show different views of an end plate 110, which also has fully formed collar support fingers 120. In addition, the geometry of the radial guide recesses 114 and the coolant outlets 118 is different from that in the other embodiment example of FIGS. 1 to 6, but in this respect without fundamental functional differences between the two embodiments.

A collar support finger 120 is provided on a circumferential region of each of the radial guide recesses 114, which extends radially inwards from the annular contour 12 further than the winding grooves 4 of the stator 1. The circumferential extension of the collar support fingers is designed such that each finger 120 exactly covers the circumferential space between two winding grooves 4, so that the collar support finger 120 can optimally serve to support the hairpin curvature.

The collar support fingers 120 are formed with the material of a hard component of a 2-component injection-molded component and manufactured in such a way that twisting results in axial compression with the laminated core, which contributes to coolant tightness. In the illustrated embodiment example, a single circumferential seal 115 is provided on the annular contour 12 radially within the radial guide recesses 114 for the sealing effect. The circumferential seal 115 is formed with the (in particular elastomer) material of a soft component of the 2-component injection-molded part.

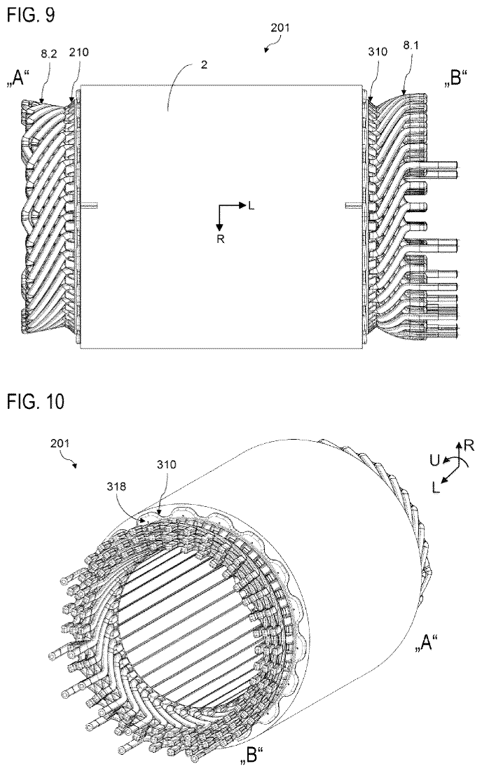

In FIG. 9, a stator 201 is shown with a first end plate 210 according to a third exemplary embodiment of the invention on the “A” side of the electric drive machine and a second end plate 310 according to a fourth exemplary embodiment of the invention on the “B” side of the electric drive machine.

The collar support fingers 220 and 320 of the two end plates 210 and 310 each have a support projection 222 and 322, respectively, which extends on the winding head side D beyond the axial extension of the annular contour 12. The support projections 222 and 322 each have a rounded, roof-like support surface 224 and 226.

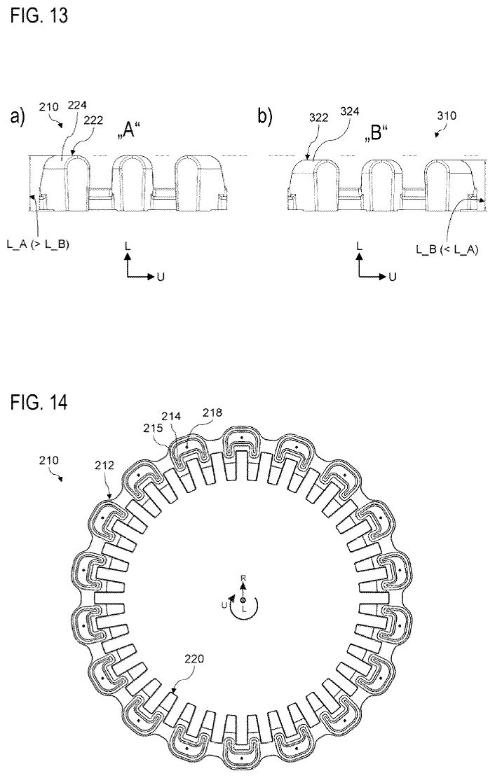

The end plates 210 and 310 differ in the longitudinal extension (along the longitudinal axis L) of a respective support projection 222 or 322 and the design of a respective associated support surface 224 or 324. The differences in design and function can be seen in detail, in particular in FIG. 13:

During the twisting process, the hairpins are pulled slightly towards the shift ring side, which is why the “A” side constricts. For this reason, the “A” and “Off” sides also have different shapes of the collar support finger contour on the star ring.

The “A” side contour has a shape that already takes into account the mechanical shaping of the hairpin roofs; therefore, the support projections 222 are axially longer with an axial extension L_A and the support surfaces 224 are rounded like roofs in such a way that the roofs can be shaped and/or applied to them. The “Eliminated contour takes the twisting process into account, so that the support projections 322 are axially shorter with an axial extension L_B.

In FIG. 10, the stator 201 of FIG. 9 is shown in an oblique view of the “B” side. In this view, it becomes clear that the coolant outlets 318 of the end plate 310 (and also the coolant outlets 218 of the end plate 210 on the “A” side, which are not visible here) are designed as circular recesses—and are relatively small in order to support a high ejection pressure.

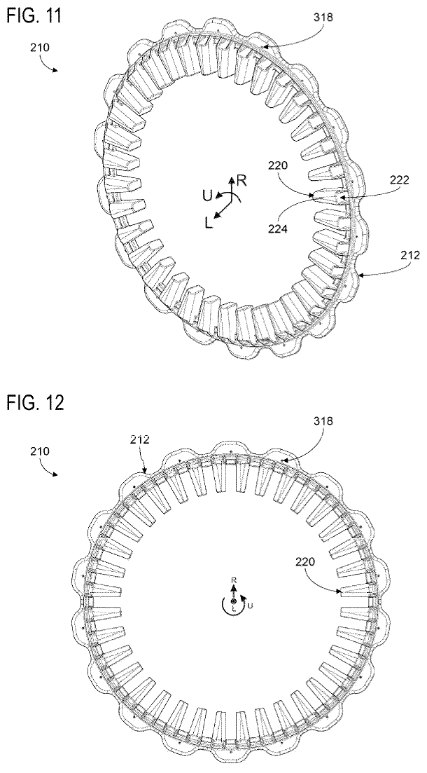

In FIG. 11, the end plate 210 on the “A” side of the electric drive machine is shown in an oblique frontal view. In particular, the collar support fingers 220 with the support projections 222 and the shape of the support surfaces 224 are clearly recognizable.

In FIG. 12, the end plate 210 is shown in a frontal view. In this view, the radially outer wave form of the annular contour 212, which serves to save material at the circumferential positions at which no coolant guidance is required, becomes particularly clear.

In FIG. 14, the end plate 210 is shown in a rear view, so that the radial guide recesses 214 are recognizable. Each of the radial guide recesses 214, which are spaced apart from one another in the circumferential direction, is formed with a circumferential individual seal 215 for guiding coolant from two adjacent coolant axial channels to the coolant outlet 218, the respective individual seal 215 being formed only for sealing this one radial guide recess 214 and from a softer sealing plastic (for example in the sense of a 2K component; in particular from an elastomer material).

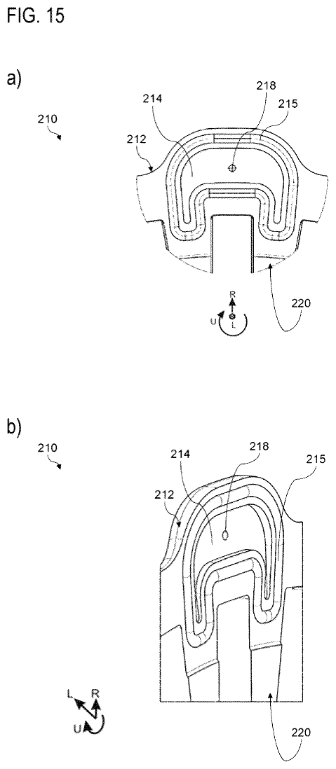

FIG. 15 shows a/b, a radial guide recess 214 of the end plate 210 from FIG. 14, which is sealed in itself, enlarged in different views.

### LIST OF REFERENCES

Stator 1, 201
Laminated core 2
Winding grooves 4
Coolant axial channels 6
Stator winding head 8.1, 8.2
End disc 10, 110, 210, 310
Annular contour 12, 212
Radial guide recesses 14, 114, 214
Coolant axial channel 16
Coolant outlet 18, 118, 218, 318
Circumferential seal 115
Collar support fingers 120, 220, 320
Single seal 215
Support projection 222, 322
Support surface 224, 324
A-side of the electric drive machine A
B-Side of the electric drive machine B
End of winding D
Coolant flow F
Laminated packet side P
Radial direction R
Circumferential direction U
Ring wall thickness X_R
Axial extensions L_A, L_B

1.-18. (canceled)

19. An end plate for a laminated core of a stator of an electrical machine, comprising:
an annular contour extending between a laminated core side and a winding head side of the end plate; and
a plurality of radial guide recesses on the laminated core side, which radial guide recesses are spaced apart from one another in a circumferential direction of the annular contour; and
a collar support finger on a circumferential region of one, several or all of the plurality of radial guide recesses, each collar support finger extending radially inward.

20. The end plate according to claim 19, wherein
the radial guide recesses are each set up to guide a coolant flow from a coolant axial channel of the laminated core, arranged further inward on the stator in a radial direction, to a coolant outlet arranged radially further outward on the end plate, toward the winding head side; and
the radial guide recesses are spaced apart from one another in accordance with a positioning of the coolant axial channels of the laminated core.

21. The end plate according to claim 20, wherein the radial guide recesses are uniformly spaced apart from one another.

22. The end plate according to claim 20, wherein
each radial guide recess or, in each case, two or more radial guide recesses are jointly assigned a coolant outlet.

23. The end plate according to claim 20, wherein
the coolant outlet is designed as a spray nozzle.

24. The end plate according to claim 20, wherein
a coolant outlet located further down in an installation position of the stator has a smaller cross-section than a coolant outlet arranged further up.

25. The end plate according to claim 19, wherein the end plate comprises a steel material and/or at least one plastic material.

26. The end plate according to claim 19, wherein
the end plate is a multi-component part with a hard component for forming the radial guide recesses and the annular contour, and with one or more soft components for forming a seal to the laminated core.

27. The end plate according to claim 19, further comprising:
a plurality of seals which are spaced apart from one another in the circumferential direction of the annular contour and are formed circumferentially around one or more of the radial guide recesses.

28. The end plate according to claim 19, wherein the end plate is formed from two or more identically formed, circumferential parts.

29. The end plate according to claim 19, wherein
a respective collar support finger extends radially along a part, or an entirety of, a radial extension of winding grooves of the stator, at a circumferential position of each winding groove.

30. The end plate according to claim 19, wherein
the collar support finger(s) are formed with material of a hard component of a 2-component injection-molded part.

31. The end plate according to claim 19, wherein
the collar support finger(s) are arranged within an axial region of the radial guide recesses.

32. The end plate according to claim 19, wherein
the collar support finger(s) comprise a support projection extending on the winding head side beyond the axial extension of the annular contour.

33. The end plate according to claim 32, wherein
the support projection has a rounded roof-shaped supporting surface.

34. A stator for an electric drive machine in a motor vehicle, comprising:
a laminated core with a plurality of winding slots; and
a stator winding head on both sides of the laminated core, starting from respective axial ends of the winding slots; and
end plates according to claim 19,
wherein a respective end plate is arranged on each side of the laminated core.

35. The stator according to claim 34, wherein coolant axial channels are arranged between the winding slots in the circumferential direction.

36. The stator according to claim 35, wherein the respective end plates are bonded to the laminated core in a coolant-tight manner via a baking varnish.

37. The stator according to claim 34, wherein
the radial guide recesses on the laminated core side of the end plates are delimited by an elastic plastic component and braced with the laminated core.
